(19) United States
(12) Patent Application Publication
(10) Pub. No.: US 2015/0013367 A1
(43) Pub. Date: Jan. 15, 2015

(54) VEHICLE COOLING WITH ADJUSTABLE FLOW EXPANSION VALVE

(71) Applicant: Magna E-Car Systems of America, Inc., Auburn Hills, MI (US)

(72) Inventor: Neil Carpenter, Clarkston, MI (US)

(21) Appl. No.: 14/376,737

(22) PCT Filed: Feb. 25, 2013
(86) PCT No.: PCT/US2013/027581

§ 371 Date: Aug. 5, 2014

Related U.S. Application Data
(60) Provisional application No. 61/616,829, filed on Mar. 28, 2012.

(51) Int. Cl. H01M 10/613; F25B 41/04; F25B 49/02; H01M 10/625

(52) U.S. Cl. CPC H01M 10/5004; H01M 10/5016; F25B 41/043; F25B 49/02
USPC 62/222

(57) ABSTRACT

A cooling apparatus for a vehicle includes a compressor 40 and a condenser 38 arranged for flow of refrigerant. The condenser can be connected to a cabin cooling expansion valve 41 positioned between the condenser and a cabin cooling heat exchanger 50 used to cool a passenger cabin 13 of the vehicle. A battery cooling heat exchanger 32 is connected to the condenser and is used to cool a traction motor battery of the vehicle. A battery cooling expansion valve 31 is connected to the condenser and the battery cooling heat exchanger. At least one of the cabin cooling expansion valve 41 and the battery cooling expansion valve 31 is an electronic expansion valve. A controller 80 can control the one or more electronic expansion valves based on desired refrigerant flow rates through the cabin cooling heat exchanger and the battery cooling heat exchanger.

### CROSS-REFERENCE TO RELATED APPLICATIONS

This application claims the benefit of and priority to U.S. Provisional Application No. 61/616,829 filed Mar. 28, 2012. The entire disclosure of the above-noted provisional application is incorporated herein by reference.

### FIELD OF THE INVENTION

This disclosure relates to vehicles that have at least an electric traction motor.

### BACKGROUND OF THE INVENTION

This section provides a general summary of the disclosure and is not a comprehensive disclosure of its full scope or all of its features and aspects.

Vehicles that can be driven by electric traction motors may be known as electric vehicles or hybrid vehicles, depending on their configuration and content. For at least some of the time, these vehicles run on battery power alone. Due to low power-to-weight ratios in even the best batteries, conserving electrical power is important to efficient operation of such vehicles. The thermal systems in vehicles that use electric traction motors offer areas for improved efficiency and reduced energy consumption.

### SUMMARY OF THE INVENTION

This section provides a general summary of the disclosure and is not a comprehensive disclosure of its full scope or all of its features and aspects.

A cooling apparatus constructed in accordance with the present disclosure uses an expansion valve for cabin cooling and another expansion valve for battery cooling. At least one of these expansion valves is an electronic expansion valve that is controlled based on desired refrigerant flow rates through heat exchangers at the cabin and the battery circuit.

In accordance with one aspect of the present disclosure, a cooling apparatus adapted for use in a vehicle having an electric traction motor and a battery system for providing electric power to the traction motor is disclosed. This cooling apparatus includes a compressor; a condenser fluidically connected to the compressor; a cabin cooling expansion valve connected between the condenser and a cabin cooling heat exchanger that is configured to cool a passenger cabin of the vehicle; a battery cooling expansion valve connected between the condenser and a battery cooling heat exchanger that is configured to cool a thermal load associated with the battery system; and a controller operable to control at least one of the two expansion valves in coordination with control of the compressor based on selected refrigerant flow rates through the cabin heat exchanger and the battery cooling heat exchanger.

This particular aspect is advantageous since variable control over at least one of the expansion valves, based on desired refrigerant flow rates through the corresponding heat exchangers, avoids providing refrigerant where it is not needed while concurrently allowing precise control over the amount of refrigerant supplied to cool the passenger cabin and/or the battery system.

In a first embodiment of the cooling apparatus, the cabin cooling expansion valve is a non-adjustable fixed-flow valve and the battery cooling expansion valve is an electrically-actuated adjustable (i.e. variable) flow valve controlled by the controller. In an optimal second embodiment, the cooling apparatus can further include an on/off type of electrically-actuated flow control valve disposed between the condenser and the fixed flow cabin cooling expansion valve that is controlled by the controller. Thus, the controller can control the overall flow rate of refrigerant supplied by the compressor, control the amount of refrigerant flow delivered to the battery cooling heat exchanger, and control whether or not any refrigerant supplied by delivered to the cabin cooling heat exchanger.

In a third embodiment, the battery cooling expansion valve is a non-adjustable fixed-flow valve and the cabin cooling expansion valve is an electrically-actuated adjustable (i.e. variable) flow valve controlled by the controller. In an optional fourth embodiment, the cooling apparatus can further include an on/off type of electrically-actuated flow control valve disposed between the condenser and the fixed-flow battery cooling expansion valve. Thus, when the controller determines that the battery system needs to be cooled, the fixed-flow control valve is opened to permit refrigerant flow to the battery cooling heat exchanger. At the same time, the compressor speed may be regulated to provide a desired refrigerant flow rate to the battery cooling expansion valve. The controller then adjusts the cabin cooling expansion valve to ensure that the cabin cooling heat exchanger provides the desired cabin cooling.

In a fifth embodiment, the cooling apparatus can be configured such that both of the expansion valves are electrically-actuated adjustable (i.e. variable) flow valves that are controlled by the controller. The controller can be programed to simultaneously or independently control the expansion valves to control the refrigerant flow rates based on the cooling required in the cabin and at the battery system. Accordingly, coordinated control of both of the expansion valves and the compressor permits the cooling apparatus to perform at near peak efficiency while conserving energy usage.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings illustrate, by way of example only, embodiments of the present disclosure.

FIG. 1 is a perspective view of a vehicle equipped with a traction motor, a battery and a thermal management system for vehicle and battery temperature control;

FIG. 2 is a functional block diagram of the thermal management system associated with the vehicle according to an embodiment of the present disclosure;

FIG. 3 is a functional block diagram of the thermal management system associated with the vehicle according to another embodiment of the present disclosure;

FIG. 4 is a functional block diagram of the thermal management system associated with the vehicle according to a further embodiment of the present disclosure; and

FIG. 5 is a functional block diagram of the thermal management system associated with the vehicle according to yet another embodiment of the present disclosure.

### DETAILED DESCRIPTION OF THE INVENTION

Example embodiments will now be described more fully with reference to the accompanying drawings. In this regard, the exemplary embodiments are provided so that this disclosure will be thorough and fully convey the scope to those who are skilled in the art. Numerous specific details are set forth, such as specific examples of components, devices and/or methods, to provide a thorough understanding of each embodiment disclosed herein. It will be apparent to those skilled in the art that specific details need not be employed, that the exemplary embodiments may be embodied in many different forms and that neither should be construed to limit the scope of the disclosure. Finally, the terminology used herein is for purposes of describing particular exemplary embodiments only and is not intended to be limiting.

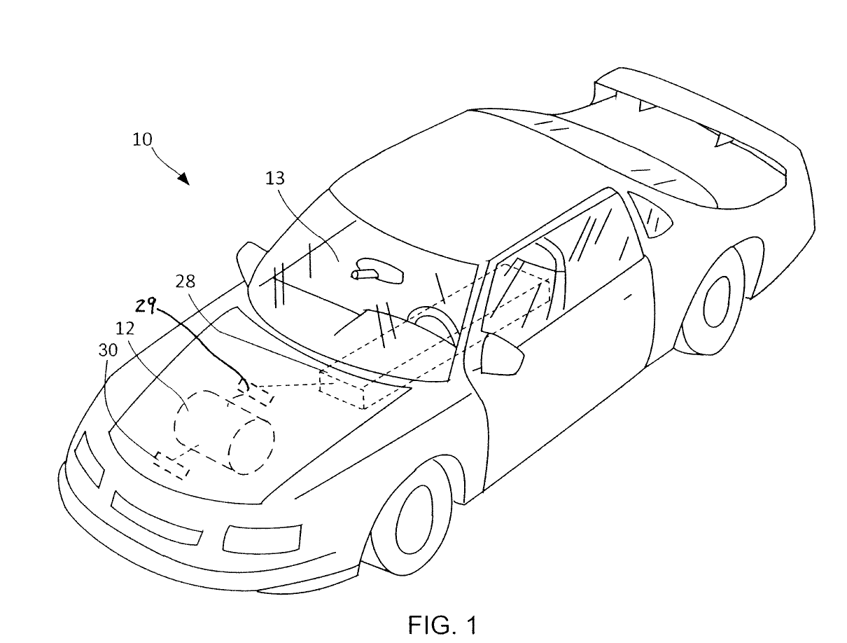

FIG. 1 shows a vehicle 10 that includes an electric traction motor 12 and at least one battery pack 28 connected to the electric traction motor 12 to drive the vehicle 10. The vehicle 10 may further include an internal combustion engine (not shown), a fuel cell or some other range extending device. The battery pack 28 provides power for use by the motor 12 and other high-voltage loads. In the embodiment shown, current from the battery pack 28 to the motor 12 is controlled by a TCM (torque control module) 29. The battery pack 28 may be any suitable type of battery pack, such as one made up of a plurality of lithium polymer cells. While one battery pack 28 is shown, it is alternatively possible to have any suitable number of battery packs, such as two or more.

The vehicle 10 further includes a battery charge control module (BCCM) 30 that is used to control charging of the battery pack 28 when the vehicle 10 is connected to an external electrical source (e.g., a 110-volt source or a 220-volt source).

The battery pack 28 and the BCCM 30 form part of a high-voltage battery system. The battery pack 28 has a temperature range within which it is preferably maintained, so as to provide it with a relatively long operating life. To remain within the preferred temperature range, the battery pack 28 sometimes requires cooling. When charging the vehicle 10, the BCCM 30 generates heat and sometimes it requires cooling to keep the BCCM 30 from overheating. The battery pack 28 and the BCCM 30 together make up all or part of what is hereinafter referred to as a battery system cooling load 36. It will be understood that in other embodiments the battery system cooling load 36 may omit the cooling of one or more of these devices.

The vehicle 10 further has a cabin 13 that may require cooling for the comfort of any vehicle occupants therein. The cabin 13 may thus be considered another cooling load, which may be referred to as an occupant-related cooling load.

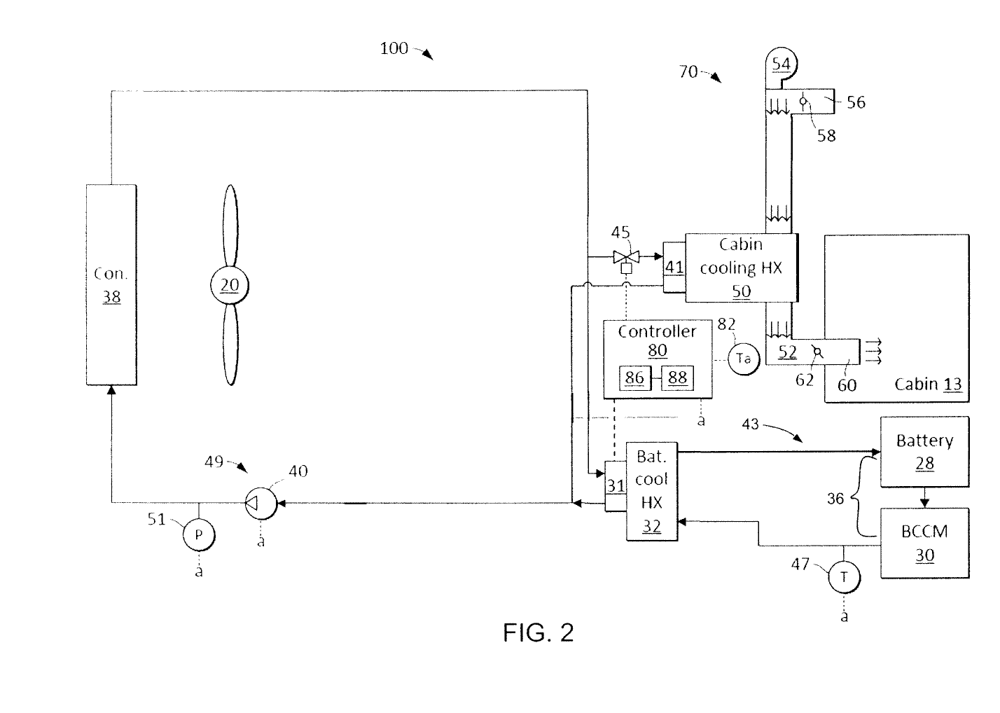

FIG. 2 shows a refrigerant system 100 for the vehicle 10 according to a first embodiment of the invention. The refrigerant system 100 is used for the cooling of the two aforementioned cooling loads in the vehicle 10, namely the vehicle cabin 13 and the battery system cooling load 36. It will be noted that, in FIGS. 2-5, fluid connections are shown in solid line, while electrical connections are shown in dashed line. Not all electrical and fluid connections are shown for the sake of clarity.

The refrigerant system 100 includes a battery cooling heat exchanger 32 for use in cooling the battery system cooling load 36. The battery cooling heat exchanger 32 may be a chiller that uses refrigerant to cool a liquid coolant that flows through a battery system coolant circuit 43. The battery system coolant circuit 43 is used to transport the liquid coolant from the battery cooling heat exchanger 32 through the components that make up the battery system cooling load 36, namely the battery pack 28 and the BCCM 30. Alternatively, the battery cooling heat exchanger 32 may be an evaporator for cooling an air flow used to cool the battery pack 28 and the BCCM 30.

The refrigerant system 100 further includes a compressor 40 and a condenser 38 which supply fresh refrigerant to the battery cooling heat exchanger 32. Refrigerant that has passed through the battery cooling heat exchanger 32 is returned to a suction side of the compressor 40. The battery cooling heat exchanger 32 is provided with a battery cooling expansion valve 31 to control the flow of refrigerant to the battery cooling heat exchanger 32. The expansion valve 31 will be discussed in further detail below. Thermal control of the battery system coolant circuit 43 can be facilitated by one or more battery circuit temperature sensors 47. In this example, the battery circuit temperature sensor 47 is located downstream of the BCCM 30 and battery pack 28.

The refrigerant system 100 further includes a cabin cooling heat exchanger 50. The cabin cooling heat exchanger 50 is a heat exchanger that uses refrigerant to cool the cabin 13. Specifically, the cabin cooling heat exchanger 50 receives refrigerant from the condenser 38 and uses the refrigerant to cool air that is sent to the cabin 13 (via an air passage 52 and a blower 54) in order to cool the cabin 13. Refrigerant leaving the cabin cooling heat exchanger 50 returns to the compressor 40. The cabin cooling heat exchanger 50 may be an evaporator. In this embodiment, the cabin cooling heat exchanger 50 is provided with a flow control valve 45 and a cabin cooling expansion valve 41 to control the flow of refrigerant to the cabin cooling heat exchanger 50. The flow control valve 45 and the expansion valve 41 of the cabin cooling heat exchanger 50 operate in conjunction with the expansion valve 31 of the battery cooling heat exchanger 32 to control sharing of refrigerant between the cabin cooling heat exchanger 50 and battery cooling heat exchanger 32. This will be discussed in further detail below.

The air passage 52 can include a return leg (not shown) to form a closed circuit to recirculate conditioned cabin air. A fresh air inlet 56 is provided to feed outside air into the air passage 52, as controlled by a controllably positionable air recirculation door 58. Conditioned air exits the air passage 52 at one or more cabin air outlets 60 as controlled by one or more air outlet doors 62. An additional air-diverting door (not shown) can be provided to control the proportions of air coming under the thermal influence of a cabin heating device (not shown) and the cabin cooling heat exchanger 50.

The vehicle 10 further includes an ambient temperature sensor 82. The ambient temperature sensor 82 is positioned to measure a temperature indicative of the environmental temperature outside the vehicle 10. The temperature sensor 82 can include a thermocouple, a thermopile, a thermistor, or the like.

The compressor 40, condenser 38, cabin cooling heat exchanger 50, battery cooling heat exchanger 32, and valves 31, 41 and 45 form the refrigerant system 100 for providing a flow of refrigerant, such as R-134a, to provide cooling to the passenger cabin 13 and the battery system coolant circuit 43, as mentioned above.

Regarding flow of refrigerant, an inlet of the condenser 38 is connected to an outlet of the compressor 40 via a conduit. The cabin cooling expansion valve 41 and the battery cooling expansion valve 31 are both connected to an outlet of the condenser 38 via one or more conduits, such as the branching conduit shown. The cabin cooling expansion valve 41 supplies refrigerant to the cabin cooling heat exchanger 50. The battery cooling expansion valve 31 supplies refrigerant to the battery cooling heat exchanger 32 and returns refrigerant to the compressor 40 via a conduit that can join the conduit returning from the cabin cooling expansion valve 41. In the embodiment shown in FIG. 2, the flow control valve 45 is positioned upstream of the cabin cooling expansion valve 41 and downstream of the condenser 38.

A refrigerant circuit pressure sensor 51 can be provided to the cooling circuit 49 at a location, such as downstream of the compressor 40 and upstream of the condenser 38. The refrigerant circuit 100 can also include a pressure relief valve (PRV) located, for example, at the compressor 40 to protect the refrigerant circuit by venting refrigerant in the event that the refrigerant pressure exceeds a selected maximum.

The vehicle 10 further includes a controller 80. The controller 80 includes a processor 86 and memory 88 coupled together. The processor 86 is capable of executing instructions stored in or originating at the memory 88. The controller 80 further includes an input-output interface (not shown) for connecting to other components of the vehicle 10 to allow the processor 86 to communicate with such components. The input-output interface can include a controller-area network bus (CAN bus) or similar.

The controller 80 can be electrically connected (dashed lines) to any of the components of the refrigerant system 100, such as the control valve 45, one or more of the expansion valves 31, 41, the compressor 40 (at “a”), the pressure sensor 51 (also at “a”), the battery circuit temperature sensor 47 (also at “a”), and the ambient temperature sensor 82. The controller 80 can be configured, by programming for example, to control and monitor operations of the refrigerant system 100. The controller 80 can be programmed to control the compressor 40 to operate based on refrigerant demand at the cabin cooling heat exchanger 50 and battery cooling heat exchanger 32, in embodiments wherein the compressor 40 is a variable speed compressor.

At least one of the cabin cooling expansion valve 41 and the battery cooling expansion valve 31 is an electronic expansion valve, and accordingly, the controller 80 can be programmed to control such an electronic expansion valve based on desired refrigerant flow rates through the cabin cooling heat exchanger 50 and the battery cooling heat exchanger 32. This advantageously avoids providing refrigerant where it is not needed, while at the same time allows precise control over the amount of refrigerant, if any, that is provided to the cabin cooling heat exchanger 50 and the battery cooling heat exchanger 32.

In the first embodiment, the cabin cooling expansion valve 41 is a fixed flow (i.e. non-adjustable) thermal expansion valve, which may be referred to as a TXV, and the battery cooling expansion valve 31 is an adjustable flow expansion valve, which may be referred to as an electronic expansion valve or an EXV. The cabin cooling expansion valve 41 can have a temperature set point that can be selected at the time of manufacture of the vehicle 10. During operation of the vehicle 10, the cabin cooling expansion valve 41 operates according to its preselected temperature set point and flow capacity (tonnage). The battery cooling expansion valve 31 is connected to the controller 80 and can be electronically controlled by the controller 80 control during operation of the vehicle 10.

The flow control valve 45 can include an actuator such as a solenoid that the controller 80 energizes to open or close the flow control valve 45. The flow control valve 45 can be selected to be normally open or normally closed. The flow control valve 45 is separate from the cabin cooling expansion valve 41. This reduces the cost of installation of the cooling system 100 in a vehicle design that originally exclusively used an internal combustion engine and that already has the fixed flow type cabin cooling expansion valve 41. That is, the cabin cooling expansion valve 41 and the cabin cooling heat exchanger 50 may be part of an existing cooling circuit system to which the other components of the refrigerant system 100 may be added, including one or more of the battery cooling heat exchanger 32, battery cooling expansion valve 31, compressor 40, condenser 38, flow control valve 45, and controller 80. This advantageously allows existing vehicle designs to be modified for use with an electric traction motor with a relatively small number of new components, the cabin cooling expansion valve 41 and the cabin cooling heat exchanger 50.

Thus, the controller 80 can control the overall flow rate of refrigerant in the refrigerant system 100 via the compressor 40. Additionally, the controller 80 can control the amount of refrigerant flow that is sent to the battery cooling heat exchanger 32 via the EXV 31 and can control whether the refrigerant is sent to the cabin cooling heat exchanger 50 via the flow control valve 45. With these capabilities, the controller 80 can ensure that the battery cooling heat exchanger 32 can receive sufficient refrigerant and won't be robbed of refrigerant when the cabin cooling heat exchanger 50 is operating. If fixed capacity expansion valves were used for both the cabin cooling and battery cooling expansion valves, the battery cooling expansion valve would have to be sized sufficiently large to ensure that the battery system cooling load 36 would receive sufficient cooling even when the cabin cooling heat exchanger 50 is in use. Unfortunately, such a large-sized expansion valve would necessitate operation of the compressor 40 at a selected speed in order to provide the refrigerant flow rate necessary for the expansion valve to operate. However, in some instances, the battery system cooling load 36 does not require a lot of cooling, and as such, the use of a high compressor speed and a correspondingly high refrigerant flow rate would be unnecessary, and therefore would consume more energy than is necessary.

By providing the electronic expansion valve 31, the flow rate into the battery cooling heat exchanger 32 can be selected to be no larger than necessary to achieve a selected amount of cooling of the battery system cooling load 36, and the compressor speed can be adjusted accordingly. These settings can be adjusted as necessary based on such factors as the ambient temperature (which impacts, among other things, condenser performance), and whether or not the cabin cooling heat exchanger 41 is being used. Thus, the refrigerant system 100 can achieve cooling of the cabin 13 and the battery system cooling load 36 using relatively less energy than some systems of the prior art that use fixed flow expansion valves for the cabin cooling heat exchanger and for the battery cooling heat exchanger. Furthermore, using fixed flow expansion valves does not permit adjustment of the relative amounts of refrigerant that are received by the cabin cooling and battery cooling heat exchangers.

In the embodiment shown in FIG. 2, the controller 80 is programmed to control the distribution of refrigerant to the battery cooling heat exchanger 32 and the cabin cooling heat exchanger 50 by controlling the battery cooling expansion valve 31 and the flow control valve 45. The controller 80 can be programmed based on the following principles. When the battery circuit temperature sensor 47 indicates to the controller 80 that the battery circuit 43 needs to be cooled, the controller 80 can adjust the battery cooling expansion valve 31 to provide a selected flow rate of refrigerant to the battery cooling heat exchanger 32. The controller 80 may increase the speed of the compressor 40 and/or the speed of the radiator fan, shown at 20 (the radiator itself is not shown). The degree of adjustment of the battery cooling expansion valve 31 and the speed of the compressor 40 can also be selected to make a desired flow rate of refrigerant available to the cabin cooling expansion valve 41 to meet cooling demanded by the cabin HVAC system. Adjusting the battery cooling expansion valve 31 to draw more refrigerant decreases the amount of refrigerant available to the cabin cooling expansion valve 41, while increasing the compressor speed increases the amount of refrigerant available to both the battery cooling expansion valve 31 and the cabin cooling expansion valve 41. When no cooling is required at the cabin 13, the controller 80 can close the flow control valve 45 to shut off refrigerant to the cabin cooling expansion valve 41. The controller 80 may also reference the ambient temperature sensor 82 when adjusting the battery cooling expansion valve 31, compressor speed, and flow control valve 45.

Because the battery cooling expansion valve 31 is adjustable, it can be sized so that at its maximum flow rate it can provide enough refrigerant to cool the battery system cooling load 36 even when there is a high cooling demand from the battery system cooling load 36 (e.g. when the vehicle is being driven aggressively) and when some refrigerant is being sent to the cabin cooling heat exchanger 50 to cool the cabin 13, but the battery cooling expansion valve 31 can be adjusted to operate with a relatively small flow rate of refrigerant when there is a relatively low cooling demand from the battery system cooling load 36. Thus, it has a large capacity when needed, but can operate with low compressor speeds when conditions permit so as to keep energy consumption low for the refrigerant system 100 when possible.

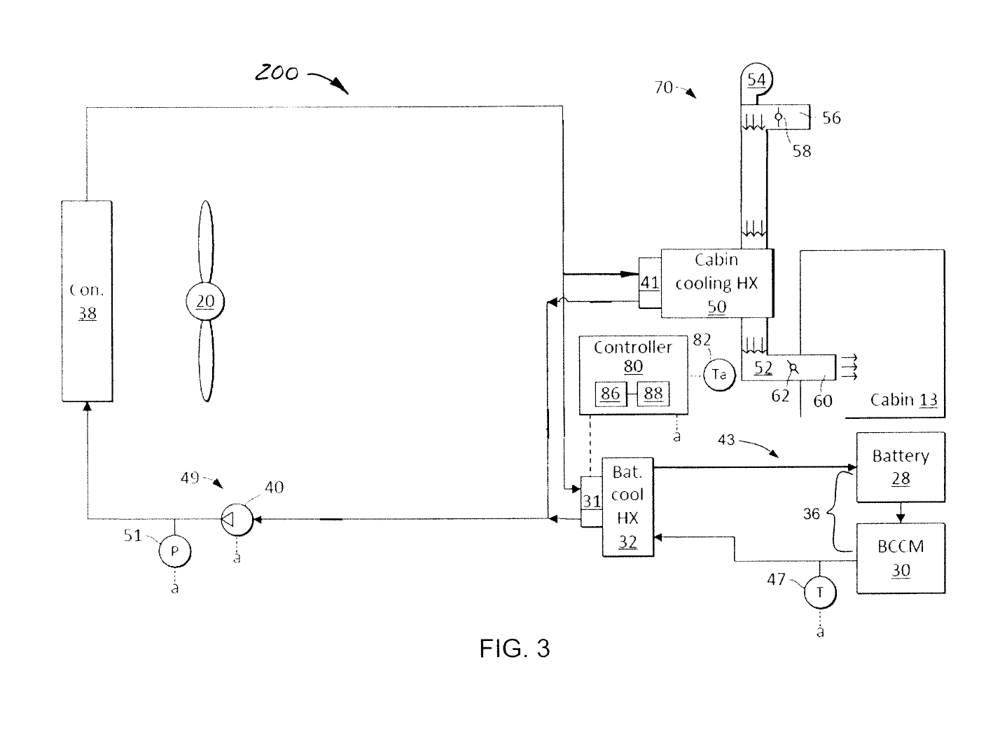

FIG. 3 shows a refrigerant system 200 adapted for use with the vehicle 10 and constructed in accordance with a second embodiment of the present invention. The refrigerant system 200 is similar to the refrigerant system 100. As such, only differences between the refrigerant system 200 and the refrigerant system 100 will be discussed in detail below. For further description of features and aspects of the refrigerant system 200, the description of the refrigerant system 100 can be referenced.

In the refrigerant system 200, the flow control valve 45 at the cabin cooling expansion valve 41 is omitted. This may be advantageous in vehicle designs where it is expected that the cabin 13 and battery circuit 43 will tend to require cooling at about the same time or when the cabin 13 is expected to demand cooling at any time when the battery circuit 43 demands cooling, (e.g., when the vehicle 10 is used at locations with hot ambient temperatures). In this embodiment, when the compressor 40 is on, some amount of refrigerant is always provided to the cabin cooling heat exchanger 50 via the cabin cooling expansion valve 41 irrespective of the adjustment of the electronic expansion valve employed as the battery cooling expansion valve 31. Thus, the added cost of the flow control valve 45 and the added complexity associated with controlling it can be eliminated when it is acceptable to provide some amount of refrigerant to the cabin cooling expansion valve 41 whenever the battery circuit 43 demands cooling.

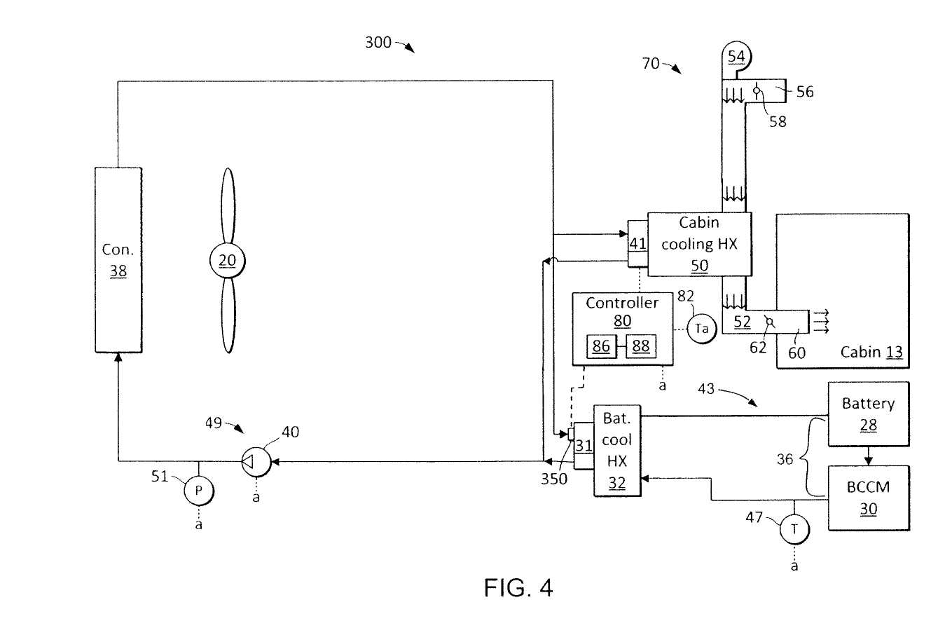

FIG. 4 shows a refrigerant system 300 adapted for use with the vehicle 10 and constructed in accordance with a third embodiment of the present invention. The refrigerant system 300 is generally similar to the refrigerant system 100. Accordingly, the only differences between the refrigerant system 300 and the refrigerant system 100 will be discussed in detail below. For further description of features and aspects of the refrigerant system 300, the description of the refrigerant system 100 can be referenced.

In the refrigerant system 300, the battery cooling expansion valve 31 is a non-adjustable (i.e. fixed flow) expansion valve with an integrated flow control valve 350 (e.g., a solenoid shutoff valve), and the cabin cooling expansion valve 41 is an electronic expansion valve. The battery cooling expansion valve 31 has a temperature set point that can be selected at the time of manufacture of the vehicle 10. During operation of the vehicle 10, the battery cooling expansion valve 31 operates according to its preselected temperature set point and flow capacity (tonnage). On the other hand, the cabin cooling expansion valve 41 is connected to the controller 80 and can be controlled by the controller 80 during operation of the vehicle 10. The integrated flow control valve 350 of the battery cooling expansion valve 31 is connected to the controller 80 to be energized by the controller 80 to open or close the cabin cooling expansion valve 31. In addition, the integrated flow control valve 350 can be selected to be normally open or normally closed.

In the refrigerant system 300, the controller 80 is programmed to control the distribution of refrigerant to the cabin cooling heat exchanger 50 and the battery cooling heat exchanger 32 by controlling the cabin cooling expansion valve 41, the compressor 40 and the flow control valve 350. Accordingly, the controller 80 can be programmed based on the following principles. When the battery circuit temperature sensor 47 indicates to the controller 80 that the battery circuit 43 needs to be cooled, the controller 80 can ensure that the integrated flow control valve 350 of the battery cooling expansion valve 31 is open to permit a desired flow rate of refrigerant to the battery cooling heat exchanger 32. At the same time, the controller 80 may increase the speed of the compressor 40 to increase the flow of refrigerant. The speed of the compressor 40 can be selected to make a desired flow rate of refrigerant available to the battery cooling expansion valve 31. However, the compressor speed also directly influences the amount of refrigerant available to the cabin cooling expansion valve 41. Accordingly, the controller 80 can adjust the cabin cooling expansion valve 41 to ensure that the cabin cooling heat exchanger 50 receives a refrigerant flow rate that meets the desired amount of cabin cooling. When no cooling is required at the battery circuit 43, the controller 80 can close the flow control valve 350 to shut off refrigerant flow to the battery cooling heat exchanger 32. The controller 80 may also reference the ambient temperature sensor 82 when adjusting the compressor speed, the cabin cooling expansion valve 41, and the flow control valve 350.

In addition, because the cabin cooling expansion valve 41 is an electronic expansion valve, the cabin cooling expansion valve 41 can be adjusted by the controller 80 to deliver a relatively small amount of refrigerant to the cabin cooling heat exchanger 50 in situations where it would be sufficient. Thus, compared to prior art vehicles that may have two fixed flow expansion valves, the cabin cooling heat exchanger 50 would not, in such a situation, steal as much refrigerant from the battery cooling heat exchanger 31 in situations where the two heat exchangers 32 and 50 are being used at the same time. This permits the battery cooling heat exchanger 32 to cool the battery system cooling load 36 more rapidly in some situations when the cabin cooling requirements exist but are low.

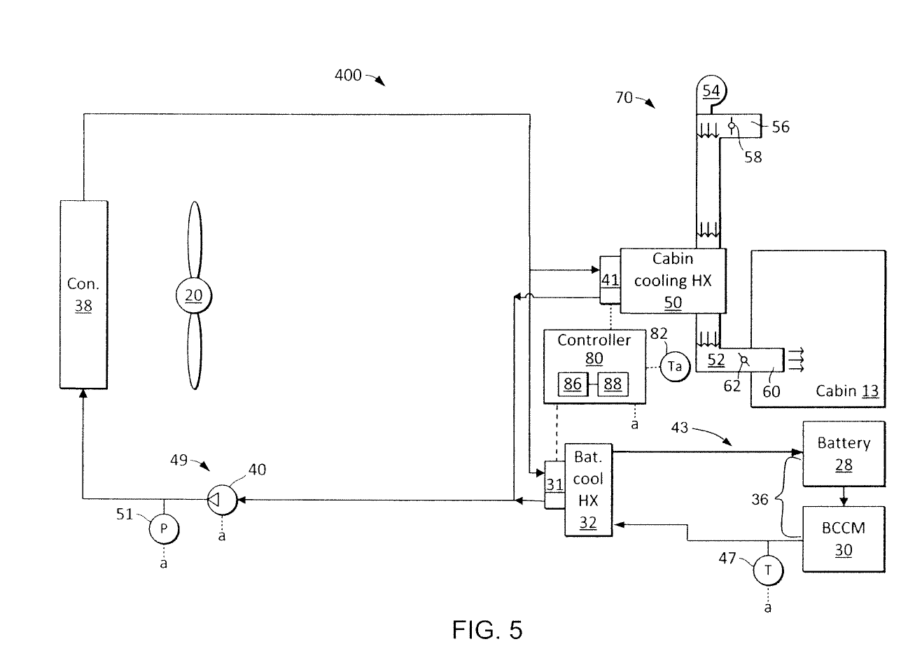

FIG. 5 shows a refrigerant system 400 adapted for use with the vehicle 10 in accordance with another embodiment of the present invention. The refrigerant system 400 is generally similar to the refrigerant system 100. Accordingly the only differences between the refrigerant system 400 and the refrigerant system 100 will be discussed in detail below. For further description of features and aspects of the refrigerant system 400, the description of the refrigerant system 100 can be referenced.

In the embodiment shown in FIG. 5, both the battery cooling expansion valve 31 and the cabin cooling expansion valve 41 are electronic (i.e. adjustable flow rate) expansion valves. Each of the battery cooling expansion valve 31 and the cabin cooling expansion valve 41 is connected to the controller 80 and can be controlled by the controller 80 during operation of the vehicle 10. Accordingly, the controller 80 is programmed to control the distribution of refrigerant to the battery cooling heat exchanger 32 and the cabin cooling heat exchanger 50 by controlling the battery cooling expansion valve 31 and the cabin cooling expansion valve 41.

In this embodiment, the controller 80 can be programmed based on the following principles. The battery cooling expansion valve 31 and cabin cooling expansion valve 41 can be adjusted to control refrigerant flow rates based on cooling required at the battery circuit 43 and at the cabin 13. When increased cooling is required at the battery circuit 43, the battery cooling expansion valve 31 can be adjusted to increase the flow rate of refrigerant to the battery cooling heat exchanger 32 and/or the cabin cooling expansion valve 41 can be adjusted to decrease the flow rate of refrigerant to the cabin cooling heat exchanger 50 if conditions permit (thereby robbing less refrigerant that would be sent to the battery cooling heat exchanger 32). Likewise, when increased cooling is required at the cabin 13, the cabin cooling expansion valve 41 can be adjusted to increase the flow rate of refrigerant to the cabin cooling heat exchanger 50 and/or the battery cooling expansion valve 31 can be adjusted to decrease the flow rate of refrigerant to the battery cooling heat exchanger 32 if conditions permit. The speed of the compressor 40 and the speed of the fan 20 can be controlled also, with increased speeds increasing the total cooling capacity available to be distributed between the battery cooling heat exchanger 32 and the cabin cooling heat exchanger 50.

In the above embodiments, use of one or more electronic expansion valves as controlled by the controller 80 allow the cooling apparatus to operate at or near peak efficiency for most or all of the time. This can save energy by providing cooling precisely when and where it is needed.

In hot ambient temperatures, when only fixed flow expansion valves are used in a vehicle cooling circuit (i.e. in a prior art refrigeration system), the cabin HVAC system and the battery cooling circuit can end up competing for refrigerant. When such valves are sized for their respective duties it can occur that the expansion valve for one of the cooling loads (e.g. the cabin) may be sized larger than the expansion valve for the other cooling load (e.g. the battery system cooling load). As a result, when both expansion valves are being used the majority of the refrigerant is sent to the larger expansion valve (e.g. to cool the cabin) even in situations where it is not needed, and even in situations where the greater amount of refrigerant is actually needed at the other expansion valve (e.g. to cool the battery). In this example, the expansion valve at the cabin cooling heat exchanger (evaporator) receives the majority of refrigerant, resulting in slower cool down of the battery circuit, which may lead to poor vehicle performance or even damage to the battery. In mild ambient temperatures when only fixed flow expansion valves are used, the cabin cooling heat exchanger (evaporator) may be maintaining its target temperature when the battery cooling heat exchanger (chiller) is turned on to cool the battery. Accordingly, the compressor speed can increase, which can cause uncomfortable temperature swings in the passenger cabin as a solenoid valve cycles to alternatively provide and withhold refrigerant to the cabin cooling heat exchanger to compensate for the increased compressor speed. Thus, use of at least one electronic expansion valve, in the manner discussed in the above disclosure, allows for improved balancing in refrigerant distribution between the cabin HVAC system and the battery cooling circuit. This can advantageously save energy by providing refrigerant precisely where and when it is needed and, further, can increase passenger comfort by avoiding refrigerant cycling at the passenger cabin HVAC system.

While it has been shown for the flow control valve 45 to be upstream from the cabin cooling expansion valve 41 it is possible for the flow control valve 45 to be positioned between the cabin cooling expansion valve 41 and the cabin cooling heat exchanger 32.

The foregoing description of the various alternative embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cooling apparatus for a vehicle that includes an electric traction motor, the cooling apparatus comprising:
a compressor;
a condenser fluidically connected to the compressor, the condenser further connected to a cabin cooling expansion valve that is positioned between the condenser and a cabin cooling heat exchanger configured to cool a passenger cabin of the vehicle;
a battery cooling heat exchanger connected to the condenser and configured to cool a battery system cooling load of the vehicle;
a battery cooling expansion valve connected to the condenser and the battery cooling heat exchanger, at least one of the cabin cooling expansion valve and the battery cooling expansion valve being an adjustable flow expansion valve; and
a controller configured to control the at least one of the cabin cooling expansion valve and the battery cooling expansion valve based on selected refrigerant flow rates through the cabin cooling heat exchanger and the battery cooling heat exchanger.

2. The vehicle cooling apparatus of claim 1, wherein the cabin cooling expansion valve is a fixed flow expansion valve and the battery cooling expansion valve is an adjustable flow expansion valve controlled by the controller.

3. The vehicle cooling apparatus of claim 2, further comprising a flow control valve connected between the condenser and the cabin cooling heat exchanger.

4. The vehicle cooling apparatus of claim 3, wherein the flow control valve is positioned upstream of the cabin cooling expansion valve.

5. The vehicle cooling apparatus of claim 3, wherein the flow control valve is separate from the cabin cooling expansion valve.

6. The vehicle cooling apparatus of claim 3, wherein the flow control valve includes a solenoid controlled by the controller.

7. The vehicle cooling apparatus of claim 2, wherein the controller is programmed to select a refrigerant flow rate for the battery cooling heat exchanger based at least in part on a temperature related to a battery system thermal load, and is programmed to control the speed of the compressor and the battery cooling expansion valve to provide the selected refrigerant flow rate for the battery cooling heat exchanger.

8. The apparatus of claim 1, wherein the cabin cooling expansion valve is an adjustable flow expansion valve and the battery cooling expansion valve is a fixed flow expansion valve.

9. The vehicle cooling apparatus of claim 8, further comprising a flow control valve controlled by the controller and operable to open and close the fixed flow battery cooling expansion valve.

10. The vehicle cooling apparatus of claim 9, wherein the controller is programmed to control actuation of the compressor, the adjustable flow cabin cooling expansion valve and the flow control valve to provide the selected refrigerant flow rates through the cabin cooling heat exchangers and the battery cooling heat exchanger.

11. The apparatus of claim 1, wherein the cabin cooling expansion valve is an adjustable flow expansion valve and the battery cooling expansion valve is an adjustable flow expansion valve.

12. The vehicle cooling apparatus of claim 11, wherein the controller is programmed to select a refrigerant flow rate for the battery cooling heat exchanger based at least in part on a temperature related to a battery system thermal load, and is programmed to control the speed of the compressor and the battery cooling expansion valve to provide the selected refrigerant flow rate for the battery cooling heat exchanger.

13. The apparatus of claim 1, wherein the battery cooling system cooling load includes a battery pack that is configured to provide power to the electric traction motor and a battery charge control module configured to control charging of the battery pack.

14. The apparatus of claim 1, wherein the battery cooling heat exchanger is a chiller and the cabin cooling heat exchanger is an evaporator.

15. A cooling apparatus for a vehicle that includes an electric traction motor and a battery system supplying electric power to the traction motor, the cooling apparatus comprising:
a compressor;
a condenser fluidically connected to the compressor;
a cabin cooling heat exchanger configured to cool a passenger cabin of the vehicle;
a battery cooling heat exchanger configured to cool the battery system;
a cabin cooling expansion valve fluidically connected between the condenser and the cabin cooling heat exchanger;
a battery cooling expansion valve fluidically connected between the condenser and the battery cooling heat exchanger; and
a controller configured to variably control actuation of the compressor and at least one of the cabin cooling expansion valve and the battery cooling expansion valve based on selected refrigerant flow rates through the cabin cooling heat exchanger and the battery cooling heat exchanger.

16. The vehicle cooling apparatus of claim 15 wherein the controller is programmed to select a refrigerant flow rate for the battery cooling heat exchanger based at least in part on a temperature related to a thermal load of the battery system, and wherein the controller is further programmed to variably control the speed of the compressor and the flow through the battery cooling expansion valve to provide the selected refrigerant flow rate for the battery cooling heat exchanger.

17. The vehicle cooling apparatus of claim 16 wherein the controller is further programmed to select a refrigerant flow rate for the cabin cooling heat exchanger based at least in part on a temperature related to the passenger cabin, and wherein the controller is further programmed to variably control the flow through the cabin cooling expansion valve to provide the selected refrigerant flow rate for the cabin cooling heat exchanger.

18. The vehicle cooling apparatus of claim 16 wherein the cabin cooling expansion valve is a fixed flow type of non-adjustable valve, and further comprising an electrically-actuated on/off type of flow control valve fluidically connected between the condenser and the cabin cooling expansion valve, the controller operable to control actuation of the flow control valve.

19. The vehicle cooling apparatus of claim 15 wherein the controller is programmed to variably control the speed of the compressor and the flow through the cabin cooling expansion valve, and wherein the controller is further operable to control actuation of an on/off type of flow control valve fluidically connected between the condenser and the battery cooling expansion valve.

20. The vehicle cooling apparatus of claim 15 wherein an output of the compressor is connected to an input of the condenser, wherein an output of the condenser is connected to an input of the cabin cooling heat exchanger and to an input of the battery cooling heat exchanger, wherein an output of the cabin cooling heat exchanger is connected to an input of the compressor, wherein an output of the battery cooling heat exchanger is connected to the input to the compressor, wherein the cabin cooling expansion valve is disposed between the output of the condenser and the input to the cabin cooling heat exchanger, and wherein the battery cooling expansion valve is disposed between the output of the condenser and the input to the battery cooling heat exchanger, and wherein the battery cooling heat exchanger is a chiller and the cabin cooling heat exchanger is an evaporator.
